(19) United States
(12) Patent Application Publication
(10) Pub. No.: US 2024/0291592 A1
(43) Pub. Date: Aug. 29, 2024

(54) TIMELINE AND CANCELLATION CONSIDERATIONS FOR DISTRIBUTED NETWORK-ENCODING

(71) Applicant: QUALCOMM Incorporated, San Diego, CA (US)

(72) Inventors: Ahmed Elshafie, San Diego, CA (US); Seyedkianoush Hosseini, San Diego, CA (US); Gabi Sarkis, San Diego, CA (US)

(21) Appl. No.: 18/174,571

(22) Filed: Feb. 24, 2023

(51) Int. Cl. H04L 1/00; H04L 1/1812

(52) U.S. Cl. CPC H04L 1/0076; H04L 1/1819

(57) ABSTRACT

Methods, systems, and devices for wireless communications are described. In some examples, a first wireless device may participate in a communication (e.g., transmit or receive), with a second wireless device, of an indication of a processing capability of either the first wireless device or the second wireless device. The processing capability may relate to support of decoding of wireless communications that are encoded in accordance with a network-encoding protocol and the indication of the processing capability may be indicative of one or more minimum time thresholds to decode and respond to corresponding network-encoded communications. Additionally, the first wireless device may transmit data as part of a network-encoding procedure, where the data is network-encoded or is to be network-encoded and may receive a feedback message associated with transmission of the data in accordance with the processing capability.

### FIELD OF TECHNOLOGY

The following relates to wireless communications, including timeline and cancellation considerations for distributed network-encoding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support timeline and cancellation considerations for distributed network-encoding. Generally, the techniques described herein may enable a wireless device, such as a user equipment (UE) or network-encoding device, to network-encode data based on a processing capability associated with decoding network-encoded messages. For example, a first wireless device may participate in communication, with a second wireless device, of an indication of a processing capability of either the first wireless device or the second wireless device, where the communication is a transmission by the first wireless device or a reception at the first wireless device. The processing capability may relate to support, by either the first wireless device or the second wireless device, of decoding of wireless communications that are encoded in accordance with a network-encoding protocol. Additionally, the indication of the processing capability may be indicative of one or more minimum time thresholds to decode and respond to corresponding network-encoded communications. As such, the first wireless device may transmit data as part of a network-encoding procedure, where the data is network-encoded or is to be network-encoded and may receive a feedback message associated with transmission of the data in accordance with the processing capability.

In some other examples, the first wireless device may be a network-encoding device, such that the network-encoding device may receive one or more source packets from one or more additional UEs, such as a source UE, and aggregate a set of transport blocks (TBs) from the source packets to generate a network-encoded message for transmission. A source UE may transmit, to the network-encoding device, a request to transmit the set of TBs indicated via the one or more source packets in accordance with a network-encoding procedure (e.g., to network-encode the set of TBs). As such, additional signaling is introduced that supports the network-encoding at the network-encoding device in accordance with the network-encoding procedure and the processing capabilities.

A method for wireless communications at a first wireless device is described. The method may include participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device, transmitting data as part of a network-encoding procedure, where the data is network-encoded or is to be network-encoded, and receiving a feedback message associated with transmission of the data in accordance with the processing capability.

An apparatus for wireless communications at a first wireless device is described. The apparatus may include a processor, memory coupled with the processor, and instructions stored in the memory. The instructions may be executable by the processor to cause the apparatus to participate in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device, transmit data as part of a network-encoding procedure, where the data is network-encoded or is to be network-encoded, and receive a feedback message associated with transmission of the data in accordance with the processing capability.

Another apparatus for wireless communications at a first wireless device is described. The apparatus may include means for participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device, means for transmitting data as part of a network-encoding procedure, where the data is network-encoded or is to be network-encoded, and means for receiving a feedback message associated with transmission of the data in accordance with the processing capability.

A non-transitory computer-readable medium storing code for wireless communications at a first wireless device is described. The code may include instructions executable by a processor to participate in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device, transmit data as part of a network-encoding procedure, where the data is network-encoded or is to be network-encoded, and receive a feedback message associated with transmission of the data in accordance with the processing capability.

In some examples of the method, apparatuses, and non-transitory computer-readable medium described herein, the one or more minimum time thresholds may be at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

In some examples of the method, apparatuses, and non-transitory computer-readable medium described herein, the first wireless device may be a network-encoding device and the method, apparatuses, and non-transitory computer-readable medium may include further operations, features, means, or instructions for receiving a request from a first user equipment (UE) to transmit one or more TBs in accordance with the network-encoding procedure, where the data may be represented by the one or more TBs and applying the network-encoding protocol to the one or more TBs in order to generate one or more network-encoded messages.

In some examples of the method, apparatuses, and non-transitory computer-readable medium described herein, transmitting the data as part of the network-encoding procedure may include operations, features, means, or instructions for transmitting the one or more network-encoded messages to one or more second UEs, responsive to the request from the first UE.

Some examples of the method, apparatuses, and non-transitory computer-readable medium described herein may further include operations, features, means, or instructions for transmitting a second indication of a maximum number of network-encoded messages the first wireless device may be to encode and transmit in accordance with the network-encoding procedure.

In some examples of the method, apparatuses, and non-transitory computer-readable medium described herein, the second indication may be based on at least one of a buffer capability of the first wireless device, a power capability of the first wireless device, or a utilization capability of the first wireless device.

In some examples of the method, apparatuses, and non-transitory computer-readable medium described herein, receiving the feedback message may include operations, features, means, or instructions for monitoring for feedback provided by one or more second UEs to the first UE, where the feedback includes the feedback message and intercepting the feedback message from the one or more second UEs.

Some examples of the method, apparatuses, and non-transitory computer-readable medium described herein may further include operations, features, means, or instructions for determining that the feedback message includes a negative acknowledgment that indicates that at least a portion of the one or more second UEs failed to decode at least a portion of the one or more TBs, encoding the portion of the one or more TBs that were not decoded by the one or more second UEs, in accordance with the network-encoding protocol, in order to generate one or more additional network-encoded messages, where TBs for which no negative acknowledgment may be received may be not represented by the one or more additional network-encoded messages, and transmitting the one or more additional network-encoded messages.

Some examples of the method, apparatuses, and non-transitory computer-readable medium described herein may further include operations, features, means, or instructions for determining that the feedback message includes an acknowledgment that indicates that all of the one or more second UEs decoded all of the one or more TBs and releasing one or more resources associated with retransmitting the one or more network-encoded messages based on the determination.

Some examples of the method, apparatuses, and non-transitory computer-readable medium described herein may further include operations, features, means, or instructions for receiving, from the first UE, a reservation message reserving the first wireless device to encode wireless communications in accordance with the network encoding protocol, where the one or more network-encoded messages may be transmitted based on receipt of the reservation message.

In some examples of the method, apparatuses, and non-transitory computer-readable medium described herein, the reservation message reserves the first wireless device for a specified duration of time.

Some examples of the method, apparatuses, and non-transitory computer-readable medium described herein may further include operations, features, means, or instructions for activating a reservation of the first wireless device by the reservation message upon receipt of an activation message from the first UE and deactivating the reservation upon receipt of a subsequent deactivation message.

In some examples of the method, apparatuses, and non-transitory computer-readable medium described herein, the reservation message may be received over a set of time or frequency resources designated for communication of the reservation message.

Some examples of the method, apparatuses, and non-transitory computer-readable medium described herein may further include operations, features, means, or instructions for receiving, from a second UE, a second reservation message reserving the first wireless device to encode additional wireless communications in accordance with the network encoding protocol, such that the first wireless device may be reserved concurrently by both the first UE and the second UE.

Some examples of the method, apparatuses, and non-transitory computer-readable medium described herein may further include operations, features, means, or instructions for receiving a cancellation message that indicates that the first wireless device may be to refrain from encoding subsequently-received TBs in accordance with the network encoding protocol.

Some examples of the method, apparatuses, and non-transitory computer-readable medium described herein may further include operations, features, means, or instructions for receiving a transition message that indicates that the first wireless device may be to transition from transmitting network-encoded messages to using non-network-encoded repetitions, where the transition message may be received via a radio resource control message, a medium access control-control element transmission, or a sidelink control information message.

In some examples of the method, apparatuses, and non-transitory computer-readable medium described herein, the first wireless device may be a first UE and the method, apparatuses, and non-transitory computer-readable medium may include further operations, features, means, or instructions for transmitting a request from the first UE to a network-encoding device to may have the network-encoding device transmit one or more TBs as the one or more network-encoded messages in accordance with the network-encoding procedure, where the data may be represented by the one or more TBs and transmitting the one or more TBs to the network-encoding device.

Some examples of the method, apparatuses, and non-transitory computer-readable medium described herein may further include operations, features, means, or instructions for receiving a second indication of a maximum number of network-encoded messages the network-encoding device may be to encode and transmit in accordance with the network-encoding procedure.

In some examples of the method, apparatuses, and non-transitory computer-readable medium described herein, the second indication may be based on at least one of a buffer capability of the network-encoding device, a power capability of the network-encoding device, or a utilization capability of the network-encoding device.

Some examples of the method, apparatuses, and non-transitory computer-readable medium described herein may further include operations, features, means, or instructions for transmitting, to the network-encoding device, a reservation message reserving the network-encoding device to encode wireless communications in accordance with the network encoding protocol.

In some examples of the method, apparatuses, and non-transitory computer-readable medium described herein, the reservation message reserves the network-encoding device for a specified duration of time.

In some examples of the method, apparatuses, and non-transitory computer-readable medium described herein, the reservation message may be transmitted over a set of time or frequency resources designated for communication of the reservation message.

Some examples of the method, apparatuses, and non-transitory computer-readable medium described herein may further include operations, features, means, or instructions for transmitting a cancellation message that indicates that the network-encoding device may be to refrain from encoding subsequently-transmitted TBs in accordance with the network encoding protocol.

Some examples of the method, apparatuses, and non-transitory computer-readable medium described herein may further include operations, features, means, or instructions for transmitting a transition message that indicates that the network-encoding device may be to transition from transmitting network-encoded messages to using non-network-encoded repetitions, where the transition message may be transmitted via a radio resource control message, a medium access control-control element transmission, or a sidelink control information message.

Some examples of the method, apparatuses, and non-transitory computer-readable medium described herein may further include operations, features, means, or instructions for transmitting the cancellation message may be based on a priority of the one or more TBs, a quality of service requirement associated with the one or more TBs, a packet delay budget associated with the one or more TBs, or any combination thereof.

A method for wireless communications at a UE is described. The method may include transmitting an indication of a processing capability of the UE to support decoding of wireless communications that are encoded in accordance with a network encoding protocol, where the indication of the processing capability is indicative of one or more minimum time thresholds for the UE to decode and respond to corresponding network-encoded communications, receiving one or more network-encoded messages, and transmitting a response message responsive to the one or more network-encoded messages in accordance with the processing capability of the UE.

An apparatus for wireless communications at a UE is described. The apparatus may include a processor, memory coupled with the processor, and instructions stored in the memory. The instructions may be executable by the processor to cause the apparatus to transmit an indication of a processing capability of the UE to support decoding of wireless communications that are encoded in accordance with a network encoding protocol, where the indication of the processing capability is indicative of one or more minimum time thresholds for the UE to decode and respond to corresponding network-encoded communications, receive one or more network-encoded messages, and transmit a response message responsive to the one or more network-encoded messages in accordance with the processing capability of the UE.

Another apparatus for wireless communications at a UE is described. The apparatus may include means for transmitting an indication of a processing capability of the UE to support decoding of wireless communications that are encoded in accordance with a network encoding protocol, where the indication of the processing capability is indicative of one or more minimum time thresholds for the UE to decode and respond to corresponding network-encoded communications, means for receiving one or more network-encoded messages, and means for transmitting a response message responsive to the one or more network-encoded messages in accordance with the processing capability of the UE.

A non-transitory computer-readable medium storing code for wireless communications at a UE is described. The code may include instructions executable by a processor to transmit an indication of a processing capability of the UE to support decoding of wireless communications that are encoded in accordance with a network encoding protocol, where the indication of the processing capability is indicative of one or more minimum time thresholds for the UE to decode and respond to corresponding network-encoded communications, receive one or more network-encoded messages, and transmit a response message responsive to the one or more network-encoded messages in accordance with the processing capability of the UE.

In some examples of the method, apparatuses, and non-transitory computer-readable medium described herein, the one or more minimum time thresholds may be at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 illustrates an example of a wireless communications system that supports timeline and cancellation considerations for distributed network-encoding in accordance with one or more aspects of the present disclosure.

FIG. 2 illustrates an example of a wireless communications system that supports timeline and cancellation considerations for distributed network-encoding in accordance with one or more aspects of the present disclosure.

FIG. 3 illustrates an example of a process flow that supports timeline and cancellation considerations for distributed network-encoding in accordance with one or more aspects of the present disclosure.

FIG. 4 illustrates an example of a process flow that supports timeline and cancellation considerations for distributed network-encoding in accordance with one or more aspects of the present disclosure.

FIGS. 5 and 6 illustrate block diagrams of devices that support timeline and cancellation considerations for distributed network-encoding in accordance with one or more aspects of the present disclosure.

FIG. 7 illustrates a block diagram of a communications manager that supports timeline and cancellation considerations for distributed network-encoding in accordance with one or more aspects of the present disclosure.

FIG. 8 illustrates a diagram of a system including a device that supports timeline and cancellation considerations for distributed network-encoding in accordance with one or more aspects of the present disclosure.

FIGS. 9 through 11 illustrate flowcharts showing methods that support timeline and cancellation considerations for distributed network-encoding in accordance with one or more aspects of the present disclosure.

### DETAILED DESCRIPTION

Some wireless communications systems may support distributed network-encoding to minimize the overhead of retransmitting packets. In some examples, a first wireless device, which may be a first user equipment (UE), may aggregate a set of transport blocks (TBs) and apply a network-encoding protocol to the set of TBs to generate a network-encoded message (e.g., packet) for transmission. In some other examples, the first wireless device may be a network-encoding device, such that the network-encoding device may receive one or more source packets from one or more additional UEs, such as the first UE, and aggregate a set of TBs from the source packets to generate a network-encoded message for transmission. In such cases, the one or more additional UEs may transmit, to the network-encoding device, a request to transmit the set of TBs indicated via the one or more source packets in accordance with a network-encoding procedure (e.g., to network-encode the set of TBs). In either scenario, additional signaling may be useful to support the network-encoding in accordance with the network-encoding procedure.

As such, techniques described herein may support additional signaling to support timeline and cancellation considerations for distributed network-encoding. For example, a first UE (e.g., a source UE), a network-encoding device, a second UE (e.g., a receiver UE), or any combination thereof, may communicate (e.g., transmit or receive) control signaling indicating one or more minimum time thresholds to decode and respond to corresponding network-encoded communications. For example, the one or more time thresholds may include a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message. Additionally, or alternatively, the network-encoding device may transmit, to a source UE, an indication of a maximum quantity of network-encoded messages that the network-encoding device is capable of encoding and transmitting. Additionally, or alternatively, the source UE may transmit, to the network-encoding device, a reservation message reserving the network-encoding device to encode wireless communications in accordance with the network-encoding protocol. As such, the source UE or the network-encoding device may transmit one or more network-encoded messages to other UEs and the other UEs may transmit one or more response messages based on the one or more network-encoded messages, in accordance with the one or more minimum time thresholds.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to timeline and cancellation considerations for distributed network-encoding.

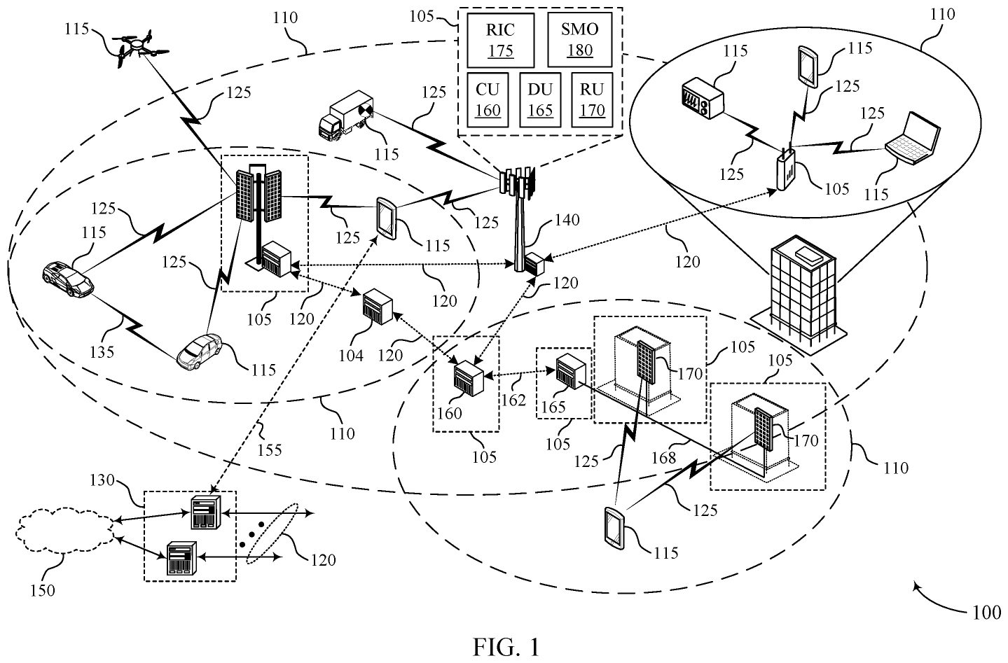

FIG. 1 illustrates an example of a wireless communications system 100 that supports timeline and cancellation considerations for distributed network-encoding in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support timeline and cancellation considerations for distributed network-encoding as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 200 may support signaling to enable timeline and cancellation considerations for distributed network-encoding (e.g., distributed network coding). In some examples, a first UE 115 may receive, from a second UE 115, an indication of one or more minimum time threshold for the second UE 115 to decode and respond to corresponding network-encoded transmissions. As such, the first UE 115 may apply a network-encoding protocol to one or more TBs) to generate one or more network-encoded messages and may transmit the one or more network-encoded messages to the second UE 115. Additionally, the first UE 115 may receive a response message responsive to the one or more network-encoded messages in accordance with the one or more minimum time thresholds.

Additionally, or alternatively, the first UE 115 may transmit, to a network-encoding device, a request for the network-encoding device to transmit one or more TBs in accordance with a network-encoding procedure. In such cases, the network-encoding device may receive, from the first UE 115, the second UE 115, or both, an indication of the one or more minimum time threshold for the second UE 115 to decode and respond to corresponding network-encoded transmissions. As such, the first UE 115 may transmit one or more TBs to the network-encoding device, such that the network-encoding device may apply the network-coding protocol to the one or more TBs to generate one or more network-encoded messages. Additionally, the network-encoding device may transmit the one or more network-encoded messages to the second UE 115. In some examples, the second UE 115 may transmit a feedback message responsive to the one or more network-encoded messages in accordance with the one or more minimum time thresholds, such that the network-encoding device may intercept the feedback message. In such cases, the network-encoding device may determine the feedback message includes a negative acknowledgement and may transmit one or more additional network-encoded messages based on the negative acknowledgement. Additionally, or alternatively, the network-encoding device may determine the feedback message includes a positive acknowledgement and may release one or more resources associated with transmitting one or more additional network-encoded messages based on the positive acknowledgement

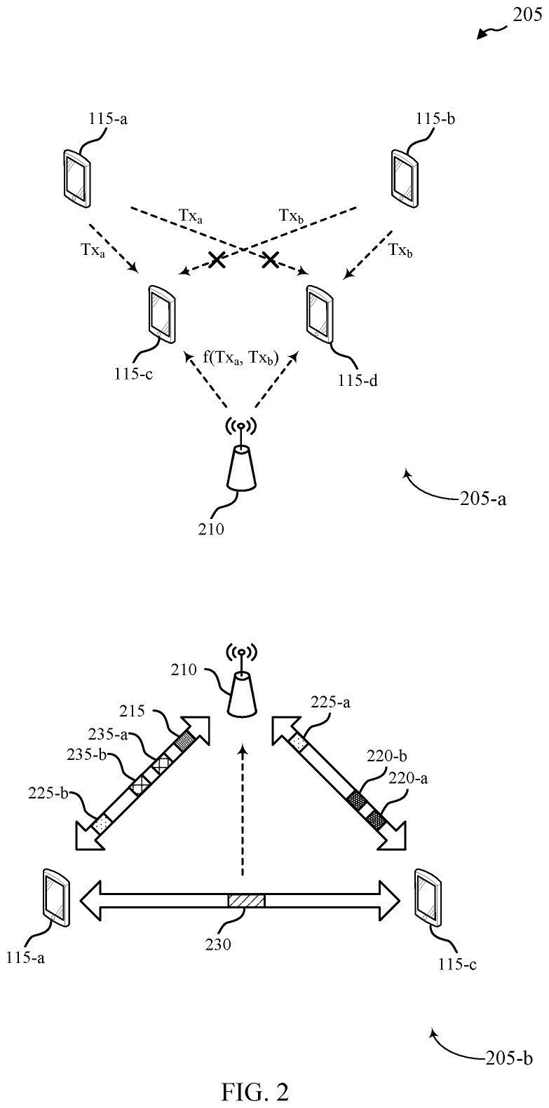

FIG. 2 illustrates an example of a wireless communications system 200 that supports timeline and cancellation considerations for distributed network-encoding in accordance with one or more aspects of the present disclosure. In some examples, the wireless communications system 200 may implement or be implemented by aspects of the wireless communications system 100. For example, the wireless communications system 200 may include one or more network entities 105 and one or more UEs 115 (e.g., a UE 115-a, and a UE 115-b), which may be examples of the corresponding devices as described with reference to FIG. 1. The wireless communications system 200 may enable communication of additional signaling to support timeline and cancellation considerations for distributed network-encoding.

In some examples, the wireless communications system 200 may support sidelink communications. For example, as depicted in scenario 205-a, one or more source UEs 115, such as a UE 115-a and a UE 115-b, may transmit packets, such as Txₐ and Tx_{b}, to one or more target UEs 115, such as a UE 115-c and a UE 115-d. In such cases, one or more UEs 115, such as the UE 115-a, the UE 115-b, or both, may reserve one or more resources for transmission of the packets (e.g., resource allocation may be reservation based in sidelink communications). For example, the one or more UEs 115 may reserve one or more sub-channels in the frequency domain and one or more slots in the time domain (e.g., limited to one slot in the time domain). Additionally, the one or more UEs 115 may reserve (e.g., for transmission of the packets) resources in a current (e.g., initial) slot and one or more future slots (e.g., slots occurring after the initial slot. In some examples, the reserved resources (e.g., initial slot and one or more future slots) may be chained (e.g., in sidelink). That is, a first transmission of a packet may be associated with a first set of time and frequency resources, a first retransmission of the packet may be associated with a second set of time and frequency resources (e.g., after the first set of time and frequency resource), and a second retransmission of the packet may be associated with a third set of time and frequency resources (e.g., after the first set and second set of time and frequency resources), such that the first set of time and frequency resources, the second set of time and frequency resources, and the third set of time and frequency resources may be chained.

In some examples, the one or more UEs 115 may refrain from using one or more reserved resources based on feedback another UE 115, such as the UE 115-c or the UE 115-d, respectively. For example, the UE 115-a may transmit a packet, such as Txₐ, to the UE 115-c via a first set of time and frequency resources, where the first set of time and frequency resources are further associated with (e.g., chained with) a second set of time and frequency resources. In some examples, the UE 115-c may transmit, to the UE 115-a, feedback indicating unsuccessful receipt of the packet. In such cases, the UE 115-a may transmit a first retransmission of the packet via the second set of time and frequency resources. Alternatively, the UE 115-c may transmit feedback indicating successful receipt of the packet, such that UE 115-a may refrain from transmitting the first retransmission of the packet (e.g., stop retransmission of a TB). In such cases, the UE 115-a may refrain from using the second set of time and frequency resources. Additionally, or alternatively, the one or more UEs 115 may support a threshold (e.g., maximum) quantity of retransmissions per packet (e.g., per TB). In some examples, the one or more UEs 115 may receive, from a network entity, another UE 115, or both, a control message indicating the threshold quantity (e.g., the threshold quantity may be pre-configured).

In some examples, the one or more UEs 115 may transmit an indication of a resource reservation (e.g., reservation information) in a control messages, such as sidelink control information (SCI). In some examples, the one or more UEs 115 may support aperiodic resource reservations. That is, the control message may indicate one or more reserved resources for transmission of one or more packets. Additionally, or alternatively, the one or more UEs 115 may support periodic resource reservations. That is, the control message may indicate a period (e.g., with a configurable value between 0 ms and 1000 ms) associated with reservation of one or more resources for transmission of one or more packets. For example, the control message may indicate one or more resources in a frequency domain, one or more resources in the time domain, and a period associated with reservation of the one or more resources in the time domain. In some examples, the one or more UEs 115 may receive control signaling (e.g., may be pre-configured) enabling periodic resource reservations (e.g., and signaling).

In some examples, network-encoding (e.g., network-coding) may be used to increase system capacity and improve resource utilization. The increased system capacity and improved resource utilization may be achieved by reducing the quantity of retransmissions in a system while maintaining a performance metric (for example, a quantity of successfully received packets). Network-encoding may also enable an increase in the quantity of UEs 115 or an increase in traffic for each UE 115. For example, as described previously with reference to scenario 205-a, one or more source UEs 115, such as the UE 115-a and the UE 115-b, may transmit packets, such as Txₐ and Tx_{b}, to one or more target UEs 115, such as the UE 115-c and the UE 115-d. Additionally (e.g., rather than the UE 115-a, the UE 115-b, or both performing retransmissions of the packets), a network-encoding device 210 may retransmit the packets to the one or more target UEs 115. That is, after an initial or original transmission, retransmissions by a source transmitter (e.g., the UE 115-a, the UE 115-b, or both) may be replaced by a retransmission by a network-encoding device 210. The retransmission by the network-encoding device 210 may be a function of the original transmissions from the one or more source UEs 115 (for example, f(Txₐ, Tx_{b})). The network-encoding device may be a network entity 105, a road-side unit (RSU), or a UE 115.

In some examples of network-encoding, single parity check codes may correct one erasure of a packet. For instance, an input of [a, b, c] may be encoded to [a, b, c, a⊕b⊕c] and then transmitted, in which a, b, and c each correspond to different packets. A receiving device, such as the UE 115-c, the UE 115-d, or both, may then recover one erasure from the network coded transmission. In particular, in examples in which the received vector is [a, ?, c, a⊕b⊕c], the erased element (for example, b) may be recovered by summing the other elements (for example, a⊕c⊕(a⊕b⊕c)=b). Network-encoding may be viewed as a linear system (for example, over a Galois field) with three variables and four linearly independent constraints in accordance with Equation 1 below.

$$[ \begin{matrix}1 & 0 & 0 \\ 0 & 1 & 0 \\ 0 & 0 & 1 \\ 1 & 1 & 1\end{matrix} ] \cdot {[ \begin{matrix}a & b & c\end{matrix} ]}^{T} = {[ \begin{matrix}a & b & c & a ⊕ b ⊕ c\end{matrix} ]}^{T} \qquad ( 1 )$$

Any three constraints (for example, one erasure) may be sufficient to find the three variables. A single network coded transmission or encoded sequence from a network-encoding device 210 may replace multiple retransmissions or encoded sequences from multiple wireless devices.

Additionally, or alternatively, in some examples of network-encoding, single parity check codes may correct two or more erasures of a packet. For instance, an input of [a, b, c] may be encoded (e.g., using a Reed-Solomon or other MDS code) to [a, b, c, a+b+c, a+α·b+α²·c] and then transmitted, in which a, b, and c each correspond to different packets, in accordance with Equation 2 below.

$$[ \begin{matrix}1 & 0 & 0 \\ 0 & 1 & 0 \\ 0 & 0 & 1 \\ 1 & 1 & 1 \\ 1 & α & {α}^{2}\end{matrix} ] \cdot {[ \begin{matrix}a & b & c\end{matrix} ]}^{T} = {[ \begin{matrix}a & b & c & a + b + c & a + α \cdot b + {α}^{2} \cdot c\end{matrix} ]}^{T} \qquad ( 2 )$$

A receiving device, such as the UE 115-c, the UE 115-d, or both, may then recover two or more erasures from the network coded transmission. That is, any k symbols (e.g., information symbols) of an n symbol codeword are sufficient to decode the k symbols.

In some examples, as depicted in scenario 205-b, the UE 115-a may transmit, to the network-encoding device 210, one or more TBs 215 (e.g., packets) including a network-encoding request flag. In other words, the UE 115-a may transmit, to the network-encoding device 210, a request to network-encode the one or more TBs 215 (e.g., apply a network-encoding protocol to the one or more TBs 215). In some examples, the network-encoding device 210 may accept the request and transmit, to the UE 115-a, a response message indicating that the network-encoding device 210 accepted the one or more TBs 215 as part of a network coded transmission (e.g., will network-encode the one or more TBs 215). As such, the network-encoding device 210 may apply the network-encoding protocol to the one or more TBs 215 received from the UE 115-a to generate one or more network-encoded messages 220-a and may transmit the one or more network-encoded messages 220-a to the UE 115-c. However, additional signaling may be useful to support the network-encoding in accordance with the network-encoding procedure.

Accordingly, techniques described herein may support timeline and cancellation considerations for network-encoding. For example, as described previously with reference to scenario 205-b, the UE 115-a may transmit, to the network-encoding device 210, a request to transmit one or more TBs 215 in accordance with a network-encoding procedure. In other words, the UE 115-a may request the network-encoding device 210 apply a network-encoding protocol (e.g., network encode) the one or more TBs 215 for transmission to the UE 115-c. In some examples, the request may be indicated via a flag in a transmission carrying the TBs 215 to be network-encoded.

Additionally, the network-encoding device may receive, from the UE 115-c, a capability message 225-a indicating one or more capabilities of the UE 115-c associated with network-encoded communications. In some cases, the capability message 225-a may indicate one or more time thresholds (e.g., minimum time thresholds) associated with receiving, decoding, responding, or any combination thereof, of network-encoded messages 220. For example, one or more minimum time thresholds may include at least one of a first minimum time threshold (e.g., N1) between receipt of a network-encoded downlink data message (e.g., network-encoded downlink data message 220) and transmission of a feedback message 230 associated with the network-encoded downlink data message, a second minimum time threshold (e.g., N2) between receipt of a network-encoded uplink control message (e.g., network-encoded uplink control message 220) and transmission of an uplink message responsive to the network-encoded uplink control message, or a third minimum time threshold (e.g., SL MinTimeGapPSFCH) between receipt of a network-encoded message 220 (e.g., network-encoded sidelink message 220) and transmission of a feedback message 230 associated with the network-encoded message 220.

As such, the network-encoding device 210 may apply the network-encoding protocol to the one or more TBs 215 to generate the one or more network-encoded messages 220-a and transmit the one or more network encoded messages 220-a to the UE 115-c. In some examples, the UE 115-c may transmit one or more feedback messages 230 (e.g., not network-encoded) to the UE 115-a based on the one or more network encoded messages 220-a (e.g., in accordance with the one or more capabilities of the UE 115-c). Additionally, the network-encoding device 210 may intercept (e.g., observed) the one or more feedback messages 230 and identify whether the one or more feedback messages 230 included positive acknowledgment feedback (ACK) or negative acknowledgment feedback (NACK). For example, the one or more feedback messages 230 may indicate that the UE 115-c successfully received and decoded the one or more network-encoded messages 220-a (e.g., ACK). As such, the network-encoding device 210 may intercept the one or more feedback messages 230 and release one or more resources associated with retransmission of the one or more TBs 215 associated with the network-encoded messages 220-a based on determining the feedback message 230 indicated successful receipt of the one or more network-encoded messages 220-a (e.g., assuming that the grant for retransmission of the one or more TBs 215 is after all feedback messages 230). In some examples, if the one or more feedback messages 230 are scheduled after resources scheduled (e.g., used) for network-encoded messages 220 (e.g., retransmissions of the one or more TBs associated with the network-encoded messages 220-a) the network-encoding device 210 may use the resources based at least on feedback (e.g., ACK/NACK) received prior to the resources. Additionally, or alternatively, the one or more feedback messages may indicate that the UE 115-c failed to receive or decode at least a portion of the one or more network encoded messages 220-a (e.g., NACK). In such cases, the network-encoding device 210 may apply the network-encoding protocol to one or more TBs 215 that the UE 115-c failed to decode (e.g., one or more TBs 215 associated with the at least portion of the one or more network encoded messages 220-a that the UE 115-c failed to receive or decode) to generate one or more network-encoded messages 220-b for transmission to the UE 115-c. In other words, the network-encoding device 210 may refrain from applying the network-encoding protocol to one or more TBs 215 that the UE 115-c successfully decoded (e.g., refrain from including the one or more TBs 215 that the UE 115-c successfully decoded in the one or more network-encoded messages 220-b).

In some examples, application of the network-encoding protocol to the one or more TBs 215 that the UE 115-failed to decode, transmission of the one or more network encoded messages 220-b, or both, may be based on one or more priorities, one or more power levels, or both. For example, the one or more network-encoded messages 220-b may be associated with a higher priority than additional network-encoded messages 220 to be transmitted by the network-encoding device 210, such that the network-encoding device 210 transmits the one or more network-encoded messages 220-b before the additional network-encoded messages 220 (e.g., higher priority transmissions can be sent quickly separately or jointly encoded while lower priority transmissions can be delayed, or sent late). In some examples, transmission of the one or more network-encoded messages 220-b may be indicated via level 1 (L1), level 2 (L2), or level 3 (L3) signaling.

In some examples, the UE 115-a may transmit, to the network-encoding device 210, a reservation message 235-a reserving the network-encoding device 210 to encode wireless communications, such as the one or more TBs 215, in accordance with the network-encoding protocol. For example, the reservation message 235-a may reserve the network-encoding device 210 for one or more transmissions, for one or more durations of time, or both. Additionally, or alternatively, the reservation message 235-a may activate a reservation of the network-encoding device 210 (e.g., the reservation message 235-a may be an activation message). In such cases, the UE 115-a may transmit a reservation message 235-b deactivating or releasing the reservation of the network-encoding device 210 (e.g., the reservation message 235-b may be a deactivation message).

In some examples, the UE 115-a may transmit the reservation message 235-a, the reservation message 235-b, or both, in accordance with a reservation procedure. That is, the reservation procedure may be associated with (e.g., include) a set of time resources (e.g., occasion), frequency resources, or both, over which a UE 115 may transmit a reservation message 235 (e.g., reference signal or indication) to a network-encoding device 210 for reserving (e.g., booking) the network-encoding device 210 (e.g., an available network-encoding device 210). In some examples, one or more UEs 115 may reserve a network-encoding device 210 at a same time based on capabilities of the network-encoding device 210. For example, the network-encoding device 210 may receive the reservation message 235-a from the UE 115-a and receive an additional reservation message 235 from an additional UE 115, such that the network-encoding device may be reserved by the UE 115-a and the additional UE 115 concurrently (e.g., simultaneously).

In some examples, the network-encoding device 210 may transmit a capability message 225-b indicating one or more capabilities of the network-encoding device 210 associated with network-encoding communications. For example, the capability message 225-b may indicate a threshold quantity (e.g., maximum quantity) of network-encoded messages 220 that the network-encoding device 205 may support (e.g., support encoding and transmitting). In some examples, the threshold quantity may be based on a buffer capability of the network-encoding device 210, a power capability of the network-encoding device 210, a utilization capability (e.g., engagement with other tasks, other transmissions, etc.) of the network-encoding device 210, or any combination thereof.

Additionally, or alternatively, the UE 115-a may transmit, to the network-encoding device 210, a cancellation message indicating that the network-encoding device 210 is to refrain from encoding subsequently-received TBs 215 in accordance with the network-encoding protocol (e.g., to allow the network-encoding device to encode a lower quantity of TBs 215). Additionally, or alternatively, the UE 115-a may transmit, to the network-encoding device 210, a transition message indicating that the network-encoding device 210 is to transition from transmitting network-encoded messages 220 to using non-network-encoded repetitions. In such cases, the transition message may be received via RRC message, MAC-control element (MAC-CE) transmission, or an SCI message (e.g., for dynamic scenarios). In some examples, transmission of the transition message (e.g., decision to use non-network-encoded transmissions) may be based on one or more priorities associated with the one or more TBs 215, one or more qualities of service (QoS) requirements associated with the one or more TBs 215, remaining packet delay budget (PDB) of transmissions (e.g., TBs 215) to be sent, or any combination thereof.

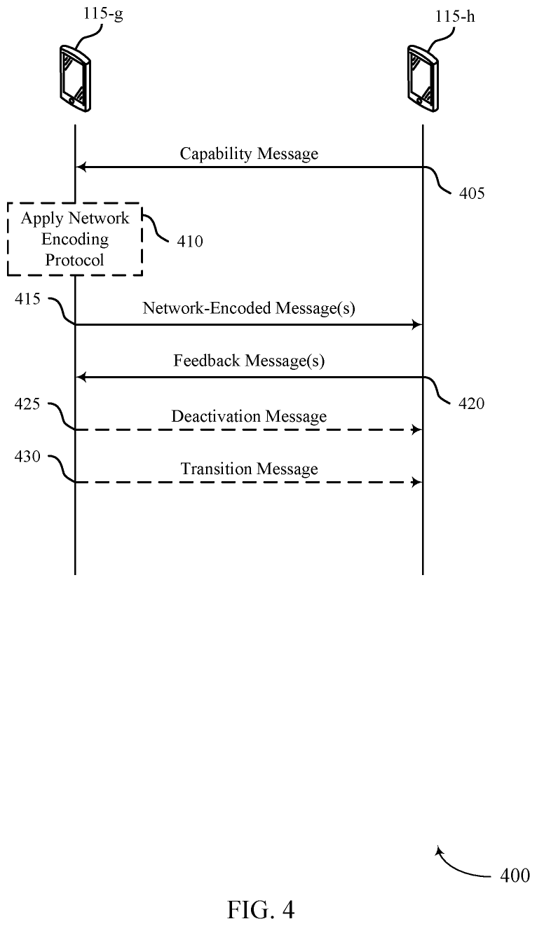

Though described in the context of a network-encoding device 210 assisting a UE 115-a, this is not to be regarded as a limitation of the present disclosure. In this regard, the UE 115-a may transmit network-encoded messages 220 to the UE 115-c (e.g., without assistance from the network-encoding device 210), as described with reference to FIG. 4. In other words, the UE 115-a may receive, from the UE 115-c, a capability message 225 indicating one or more capabilities of the UE 115-c associated with network-encoded communications. As described previously, the capability message 225 may indicate one or more time thresholds (e.g., minimum time thresholds) associated with receiving, decoding, responding, or any combination thereof, of network-encoded messages 220. In some examples, the one or more time threshold indicated in the capability message 225-a to the network-encoding device 210 may be the same as or different than the one or more time threshold indicated in the capability message 225 to the UE 115-a.

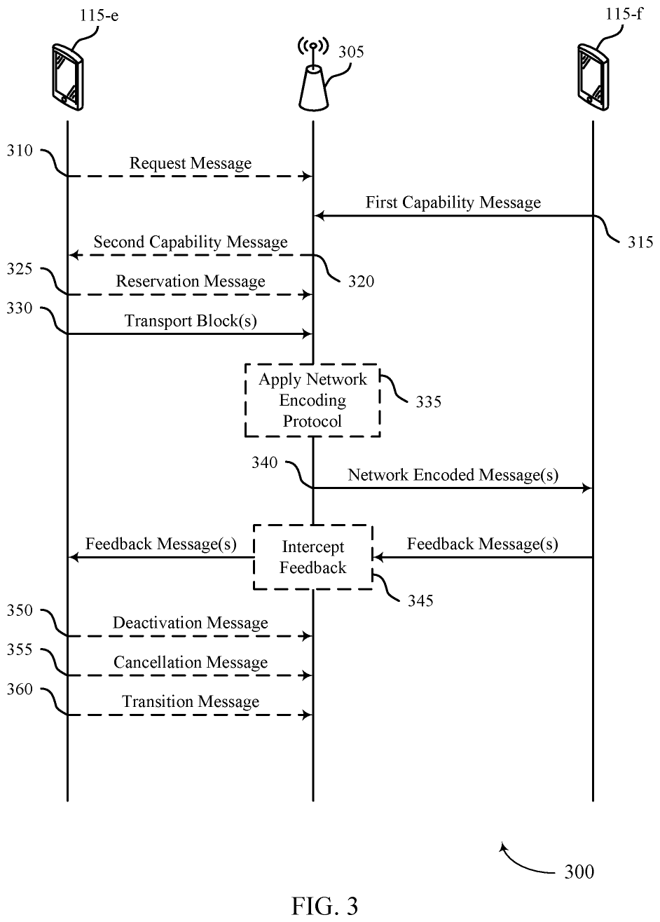

FIG. 3 illustrates an example of a process flow 300 that supports timeline and cancellation considerations for distributed network-encoding in accordance with one or more aspects of the present disclosure. In some examples, the process flow 300 may implement or be implemented by aspects of the wireless communications system 100 and the wireless communications system 200. For example, the process flow 300 may include one or more network entities 105 and one or more UEs 115 (e.g., a UE 115-c, and a UE 115-d), which may be examples of the corresponding devices as described with reference to FIG. 1. The process flow 300 may enable communication of additional signaling to support timeline and cancellation considerations for distributed network-encoding.

In some cases, at 310, the UE 115-e may transmit, to the network-encoding device 305, a request to transmit one or more TBs in accordance with the network-encoding procedure.

At 315, the UE 115-f may transmit, to the network-encoding device 305, an indication (e.g., first capability message) of a processing capability of the UE 115-f, the processing capability relating to support, by the UE 115-f, of decoding of wireless communications that are encoded in accordance with a network-encoding protocol. The indication of the processing capability may be indicative of one or more minimum time thresholds to decode and respond to corresponding network-encoded communications. For example, the one or more minimum time thresholds may include at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

In some examples, at 320, the network-encoding device 305 may transmit, to the UE 115-e, a second indication (e.g., second capability message) of a maximum number of network-encoded messages the network-encoding device 305 is to encode and transmit in accordance with the network-encoding procedure. In some examples, the indication may be based on at least one of a buffer capability of the network-encoding device 305, a power capability of the network-encoding device 305, a utilization capability of the network-encoding device 305, or any combination thereof.

In some examples, at 325, the UE 115-e may transmit, to the network-encoding device 305, a reservation message reserving the network-encoding device 305 to encode wireless communications in accordance with the network-encoding protocol. In some cases, the reservation message may reserve the network-encoding device 305 for a specified duration of time. Additionally, or alternatively, the network-encoding device 305 may activate a reservation of the network-encoding device 305 by the reservation message after (e.g., upon) receipt of an activation message from the UE 115-e. The reservation message may be received over a set of time or frequency resources designated for communication of the reservation message.

In some examples, the network-encoding device 305 may receive, from an additional UE 115, a second reservation message reserving the network-encoding device 305 to encode additional wireless communications in accordance with the network-encoding protocol, such that the network-encoding device 305 is reserved concurrently by both the UE 115-e and the additional UE 115.

At 330, the UE 115-e may transmit, to the network-encoding device 305, the one or more TBs (e.g., data) to be network-encoded.

In some cases, at 335, the network-encoding device 305 may apply the network-encoding protocol to the one or more TBs in order to generate one or more network encoded messages.

At 340, the network-encoding device 305 may transmit the one or more network-encoded messages to the UE 115-f (e.g., responsive to the request from the UE 115-e, the reservation, or both).

In some examples, at 345, the network-encoding device 305 may monitor for one or more feedback messages (e.g., feedback) provided by the UE 115-f to the UE 115-e and may intercept the one or more feedback messages. In some examples, the network-encoding device 305 may determine that the one or more feedback messages includes a negative acknowledgment that indicates that the UE 115-f failed to decode at least a portion of the one or more TBs. In such cases, the network-encoding device 305 may encode the portion of the one or more TBs that were not decoded by the UE 115-f, in accordance with the network-encoding protocol, in order to generate one or more additional network-encoded messages and transmit the one or more additional network-encoded messages to the UE 115-f In such cases, the TBs for which no negative acknowledgment is received are not represented by the one or more additional network-encoded messages. Alternatively, the network-encoding device 305 may determine that the UE 115-f decoded all of the one or more TBs. In such cases the network-encoding device 305 may release one or more resources associated with retransmitting the one or more network-encoded messages based on the determination.

In some examples, at 350, the network-encoding device 305 may receive a deactivation message deactivating the reservation of the network-encoding device 305.

In some examples, at 355, the network-encoding device 305 may receive a cancellation message that indicates that the network-encoding device 305 is to refrain from encoding subsequently-received TBs in accordance with the network-encoding protocol.

In some examples, at 360, the network-encoding device 305 may receive a transition message that indicates that the network-encoding device 305 is to transition from transmitting network-encoded messages to using non-network-encoded repetitions. The transition message may be received via a RRC message, a MAC-CE transmission, or an SCI message. Additionally, transmitting the transition message may be based on a priority of the one or more TBs, a QoS requirement associated with the one or more TBs, a PDB associated with the one or more TBs, or any combination thereof.

FIG. 4 illustrates an example of a process flow 400 that supports timeline and cancellation considerations for distributed network-encoding in accordance with one or more aspects of the present disclosure. In some examples, the process flow 400 may implement or be implemented by aspects of the wireless communications system 100, the wireless communications system 200, and the process flow 300. For example, the process flow 400 may include one or more network entities 105 and one or more UEs 115 (e.g., a UE 115-e, and a UE 115-f), which may be examples of the corresponding devices as described with reference to FIG. 1. The process flow 400 may enable communication of additional signaling to support timeline and cancellation considerations for distributed network-encoding.

At 405, the UE 115-h may transmit, to the UE 115-g, an indication (e.g., capability message) of a processing capability of the UE 115-h, the processing capability relating to support, by the UE 115-h, of decoding of wireless communications that are encoded in accordance with a network-encoding protocol. The indication of the processing capability may be indicative of one or more minimum time thresholds to decode and respond to corresponding network-encoded communications. For example, the one or more minimum time thresholds may include at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

In some cases, at 410, the UE 115-g may apply the network-encoding protocol to the one or more TBs in order to generate one or more network-encoded messages.

At 415, the UE 115-g may transmit the one or more network-encoded messages to the UE 115-h.

In some examples, at 420, the UE 115-g may monitor for one or more feedback messages (e.g., feedback) provided by the UE 115-h. In some examples, the UE 115-g may determine that the one or more feedback messages includes a negative acknowledgment that indicates that the UE 115-h failed to decode at least a portion of the one or more TBs. In such cases, the UE 115-g may encode the portion of the one or more TBs that were not decoded by the UE 115-h, in accordance with the network-encoding protocol, in order to generate one or more additional network-encoded messages and transmit the one or more additional network-encoded messages to the UE 115-h. In such cases, the TBs for which no negative acknowledgment is received are not represented by the one or more additional network-encoded messages. Alternatively, the UE 115-g may determine that the UE 115-h decoded all of the one or more TBs. In such cases the UE 115-g may release one or more resources associated with retransmitting the one or more network-encoded messages based on the determination.

In some examples, at 425, the UE 115-g nay transmit a cancellation message that indicates that the UE 115-g will refrain from encoding subsequently-transmitted TBs in accordance with the network-encoding protocol.

In some examples, at 430, the UE 115-g may transmit a transition message that indicates that the UE 115-g will transition from transmitting network-encoded messages to using non-network-encoded repetitions. The transition message may be received via a RRC message, a MAC-CE transmission, or an SCI message. Additionally, transmitting the transition message may be based on a priority of the one or more TBs, a QoS requirement associated with the one or more TBs, a PDB associated with the one or more TBs, or any combination thereof.

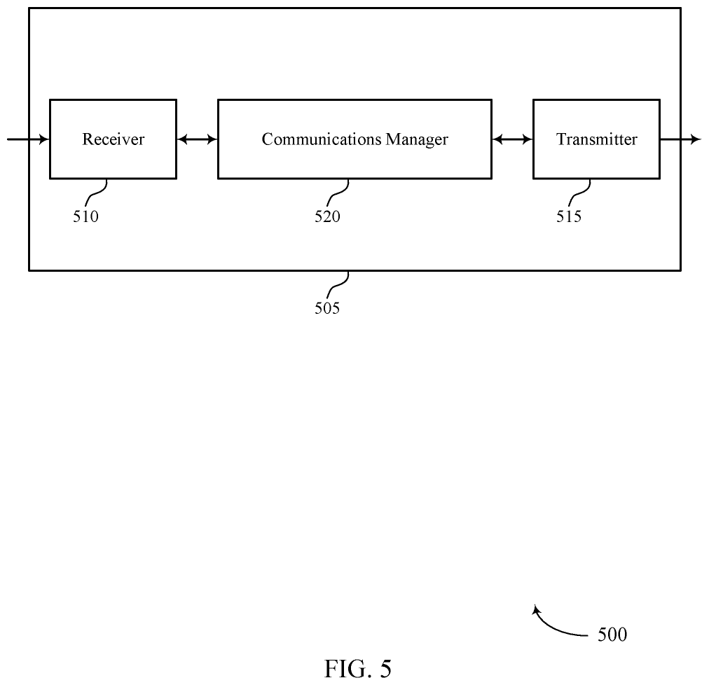

FIG. 5 illustrates a block diagram 500 of a device 505 that supports timeline and cancellation considerations for distributed network-encoding in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to timeline and cancellation considerations for distributed network-encoding). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to timeline and cancellation considerations for distributed network-encoding). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of timeline and cancellation considerations for distributed network-encoding as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a first wireless device in accordance with examples as disclosed herein. For example, the communications manager 520 may be configured as or otherwise support a means for participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device. The communications manager 520 may be configured as or otherwise support a means for transmitting data as part of a network-encoding procedure, where the data is network-encoded or is to be network-encoded. The communications manager 520 may be configured as or otherwise support a means for receiving a feedback message associated with transmission of the data in accordance with the processing capability.

Additionally, or alternatively, the communications manager 520 may support wireless communications at a UE in accordance with examples as disclosed herein. For example, the communications manager 520 may be configured as or otherwise support a means for transmitting an indication of a processing capability of the UE to support decoding of wireless communications that are encoded in accordance with a network-encoding protocol, where the indication of the processing capability is indicative of one or more minimum time thresholds for the UE to decode and respond to corresponding network-encoded communications. The communications manager 520 may be configured as or otherwise support a means for receiving one or more network-encoded messages. The communications manager 520 may be configured as or otherwise support a means for transmitting a response message responsive to the one or more network-encoded messages in accordance with the processing capability of the UE.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for timeline and cancellation considerations for distributed network-encoding which may result in reduced processing, reduced power consumption, and more efficient utilization of communication resources, among other advantages.

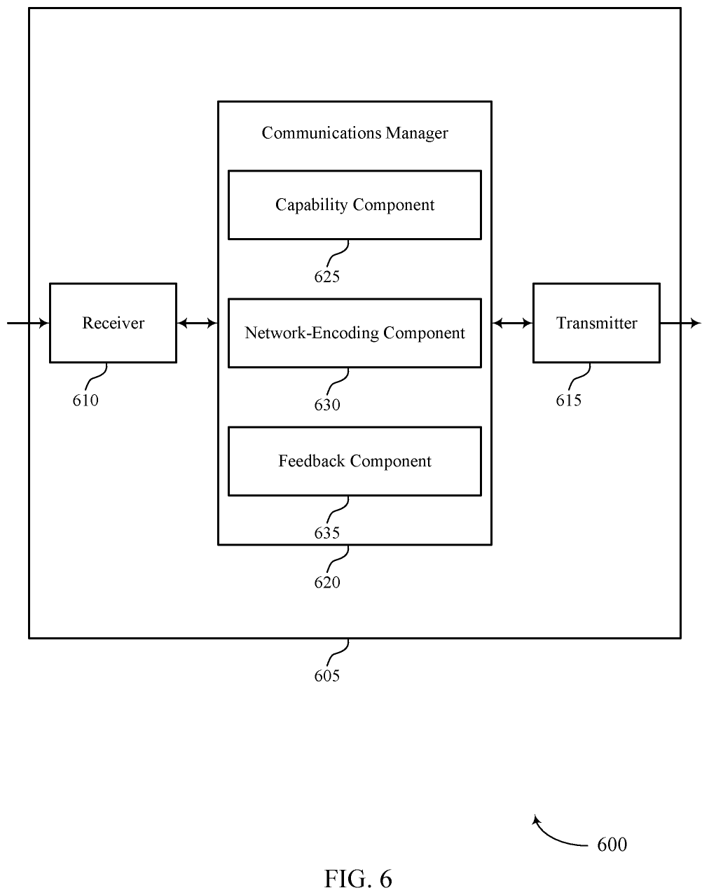

FIG. 6 illustrates a block diagram 600 of a device 605 that supports timeline and cancellation considerations for distributed network-encoding in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to timeline and cancellation considerations for distributed network-encoding). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to timeline and cancellation considerations for distributed network-encoding). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of timeline and cancellation considerations for distributed network-encoding as described herein. For example, the communications manager 620 may include a capability component 625, a network-encoding component 630, a feedback component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first wireless device in accordance with examples as disclosed herein. The capability component 625 may be configured as or otherwise support a means for participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device. The network-encoding component 630 may be configured as or otherwise support a means for transmitting data as part of a network-encoding procedure, where the data is network-encoded or is to be network-encoded. The feedback component 635 may be configured as or otherwise support a means for receiving a feedback message associated with transmission of the data in accordance with the processing capability.

Additionally, or alternatively, the communications manager 620 may support wireless communications at a UE in accordance with examples as disclosed herein. The capability component 625 may be configured as or otherwise support a means for transmitting an indication of a processing capability of the UE to support decoding of wireless communications that are encoded in accordance with a network-encoding protocol, where the indication of the processing capability is indicative of one or more minimum time thresholds for the UE to decode and respond to corresponding network-encoded communications. The network-encoding component 630 may be configured as or otherwise support a means for receiving one or more network-encoded messages. The feedback component 635 may be configured as or otherwise support a means for transmitting a response message responsive to the one or more network-encoded messages in accordance with the processing capability of the UE.

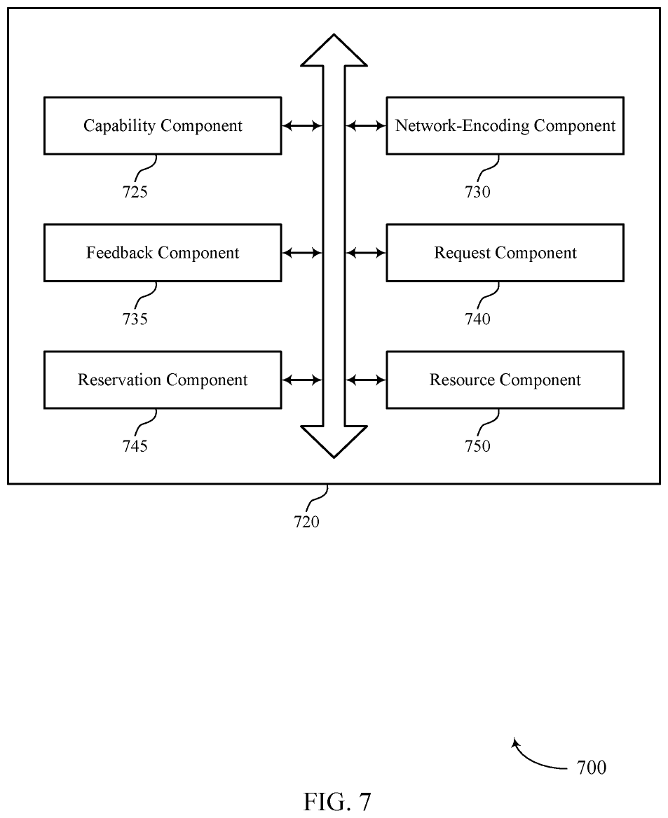

FIG. 7 illustrates a block diagram 700 of a communications manager 720 that supports timeline and cancellation considerations for distributed network-encoding in accordance with one or more aspects of the present disclosure. The communications manager 720 may be an example of aspects of a communications manager 520, a communications manager 620, or both, as described herein. The communications manager 720, or various components thereof, may be an example of means for performing various aspects of timeline and cancellation considerations for distributed network-encoding as described herein. For example, the communications manager 720 may include a capability component 725, a network-encoding component 730, a feedback component 735, a request component 740, a reservation component 745, a resource component 750, or any combination thereof. Each of these components may communicate, directly or indirectly, with one another (e.g., via one or more buses).

The communications manager 720 may support wireless communications at a first wireless device in accordance with examples as disclosed herein. The capability component 725 may be configured as or otherwise support a means for participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device. The network-encoding component 730 may be configured as or otherwise support a means for transmitting data as part of a network-encoding procedure, where the data is network-encoded or is to be network-encoded. The feedback component 735 may be configured as or otherwise support a means for receiving a feedback message associated with transmission of the data in accordance with the processing capability.

In some examples, the one or more minimum time thresholds are at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

In some examples, the first wireless device is a network-encoding device, and the request component 740 may be configured as or otherwise support a means for receiving a request from a first UE to transmit one or more TBs in accordance with the network-encoding procedure, where the data is represented by the one or more TBs. In some examples, the first wireless device is a network-encoding device, and the network-encoding component 730 may be configured as or otherwise support a means for applying the network-encoding protocol to the one or more TBs in order to generate one or more network-encoded messages.

In some examples, to support transmitting the data as part of the network-encoding procedure, the network-encoding component 730 may be configured as or otherwise support a means for transmitting the one or more network-encoded messages to one or more second UEs, responsive to the request from the first UE.

In some examples, the capability component 725 may be configured as or otherwise support a means for transmitting a second indication of a maximum number of network-encoded messages the first wireless device is to encode and transmit in accordance with the network-encoding procedure.

In some examples, the second indication is based on at least one of a buffer capability of the first wireless device, a power capability of the first wireless device, or a utilization capability of the first wireless device.

In some examples, to support receiving the feedback message, the feedback component 735 may be configured as or otherwise support a means for monitoring for feedback provided by one or more second UEs to the first UE, where the feedback includes the feedback message. In some examples, to support receiving the feedback message, the feedback component 735 may be configured as or otherwise support a means for intercepting the feedback message from the one or more second UEs.

In some examples, the feedback component 735 may be configured as or otherwise support a means for determining that the feedback message includes a negative acknowledgment that indicates that at least a portion of the one or more second UEs failed to decode at least a portion of the one or more TBs. In some examples, the network-encoding component 730 may be configured as or otherwise support a means for encoding the portion of the one or more TBs that were not decoded by the one or more second UEs, in accordance with the network-encoding protocol, in order to generate one or more additional network-encoded messages, where TBs for which no negative acknowledgment is received are not represented by the one or more additional network-encoded messages. In some examples, the network-encoding component 730 may be configured as or otherwise support a means for transmitting the one or more additional network-encoded messages.

In some examples, the feedback component 735 may be configured as or otherwise support a means for determining that the feedback message includes an acknowledgment that indicates that all of the one or more second UEs decoded all of the one or more TBs. In some examples, the resource component 750 may be configured as or otherwise support a means for releasing one or more resources associated with retransmitting the one or more network-encoded messages based on the determination.

In some examples, the reservation component 745 may be configured as or otherwise support a means for receiving, from the first UE, a reservation message reserving the first wireless device to encode wireless communications in accordance with the network-encoding protocol, where the one or more network-encoded messages are transmitted based on receipt of the reservation message.

In some examples, the reservation message reserves the first wireless device for a specified duration of time.

In some examples, the reservation component 745 may be configured as or otherwise support a means for activating a reservation of the first wireless device by the reservation message upon receipt of an activation message from the first UE. In some examples, the reservation component 745 may be configured as or otherwise support a means for deactivating the reservation upon receipt of a subsequent deactivation message.

In some examples, the reservation message is received over a set of time or frequency resources designated for communication of the reservation message.

In some examples, the reservation component 745 may be configured as or otherwise support a means for receiving, from a second UE, a second reservation message reserving the first wireless device to encode additional wireless communications in accordance with the network-encoding protocol, such that the first wireless device is reserved concurrently by both the first UE and the second UE.

In some examples, the reservation component 745 may be configured as or otherwise support a means for receiving a cancellation message that indicates that the first wireless device is to refrain from encoding subsequently-received TBs in accordance with the network-encoding protocol.

In some examples, the network-encoding component 730 may be configured as or otherwise support a means for receiving a transition message that indicates that the first wireless device is to transition from transmitting network-encoded messages to using non-network-encoded repetitions, where the transition message is received via a RRC message, a MAC-CE transmission, or a SCI message.

In some examples, the first wireless device is a first UE, and the request component 740 may be configured as or otherwise support a means for transmitting a request from the first UE to a network-encoding device to have the network-encoding device transmit one or more TBs as one or more network-encoded messages in accordance with the network-encoding procedure, where the data is represented by the one or more TBs. In some examples, the first wireless device is a first UE, and the network-encoding component 730 may be configured as or otherwise support a means for transmitting the one or more TBs to the network-encoding device.

In some examples, the capability component 725 may be configured as or otherwise support a means for receiving a second indication of a maximum number of network-encoded messages the network-encoding device is to encode and transmit in accordance with the network-encoding procedure.

In some examples, the second indication is based on at least one of a buffer capability of the network-encoding device, a power capability of the network-encoding device, or a utilization capability of the network-encoding device.

In some examples, the reservation component 745 may be configured as or otherwise support a means for transmitting, to the network-encoding device, a reservation message reserving the network-encoding device to encode wireless communications in accordance with the network-encoding protocol.

In some examples, the reservation message reserves the network-encoding device for a specified duration of time.

In some examples, the reservation message is transmitted over a set of time or frequency resources designated for communication of the reservation message.

In some examples, the reservation component 745 may be configured as or otherwise support a means for transmitting a cancellation message that indicates that the network-encoding device is to refrain from encoding subsequently-transmitted TBs in accordance with the network-encoding protocol.

In some examples, the network-encoding component 730 may be configured as or otherwise support a means for transmitting a transition message that indicates that the network-encoding device is to transition from transmitting network-encoded messages to using non-network-encoded repetitions, where the transition message is transmitted via a RRC message, a MAC-CE transmission, or a SCI message.

In some examples, transmitting the cancellation message is based on a priority of the one or more TBs, a QoS requirement associated with the one or more TBs, a PDB associated with the one or more TBs, or any combination thereof.

Additionally, or alternatively, the communications manager 720 may support wireless communications at a UE in accordance with examples as disclosed herein. In some examples, the capability component 725 may be configured as or otherwise support a means for transmitting an indication of a processing capability of the UE to support decoding of wireless communications that are encoded in accordance with a network-encoding protocol, where the indication of the processing capability is indicative of one or more minimum time thresholds for the UE to decode and respond to corresponding network-encoded communications. In some examples, the network-encoding component 730 may be configured as or otherwise support a means for receiving one or more network-encoded messages. In some examples, the feedback component 735 may be configured as or otherwise support a means for transmitting a response message responsive to the one or more network-encoded messages in accordance with the processing capability of the UE.

In some examples, the one or more minimum time thresholds are at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

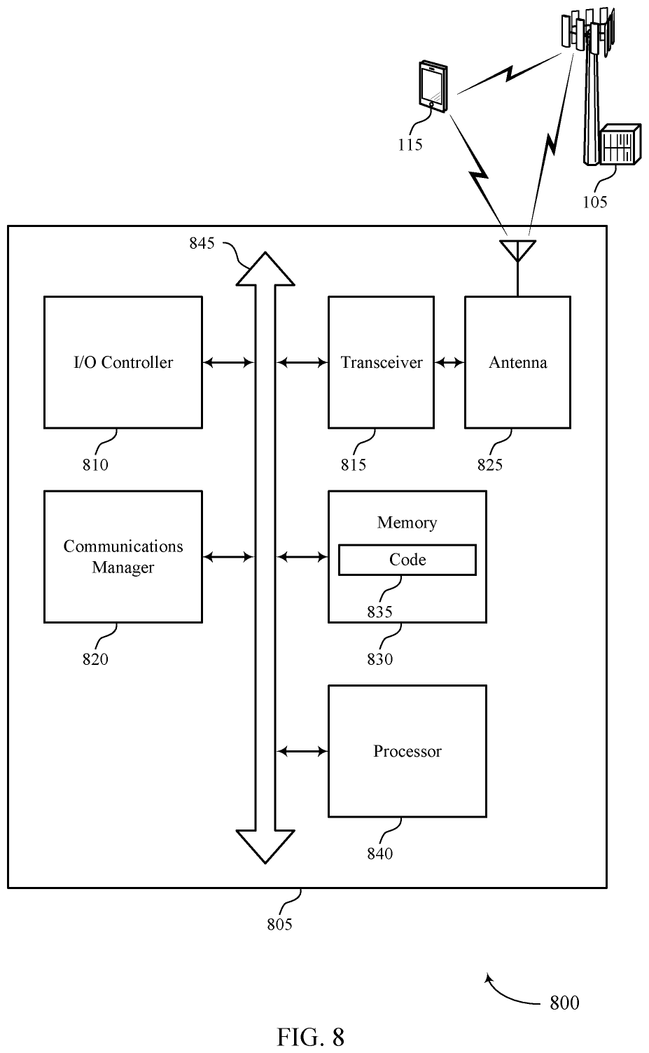

FIG. 8 illustrates a diagram of a system 800 including a device 805 that supports timeline and cancellation considerations for distributed network-encoding in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting timeline and cancellation considerations for distributed network-encoding). For example, the device 805 or a component of the device 805 may include a processor 840 and memory 830 coupled with or to the processor 840, the processor 840 and memory 830 configured to perform various functions described herein.

The communications manager 820 may support wireless communications at a first wireless device in accordance with examples as disclosed herein. For example, the communications manager 820 may be configured as or otherwise support a means for participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device. The communications manager 820 may be configured as or otherwise support a means for transmitting data as part of a network-encoding procedure, where the data is network-encoded or is to be network-encoded. The communications manager 820 may be configured as or otherwise support a means for receiving a feedback message associated with transmission of the data in accordance with the processing capability.

Additionally, or alternatively, the communications manager 820 may support wireless communications at a UE in accordance with examples as disclosed herein. For example, the communications manager 820 may be configured as or otherwise support a means for transmitting an indication of a processing capability of the UE to support decoding of wireless communications that are encoded in accordance with a network-encoding protocol, where the indication of the processing capability is indicative of one or more minimum time thresholds for the UE to decode and respond to corresponding network-encoded communications. The communications manager 820 may be configured as or otherwise support a means for receiving one or more network-encoded messages. The communications manager 820 may be configured as or otherwise support a means for transmitting a response message responsive to the one or more network-encoded messages in accordance with the processing capability of the UE.

By including or configuring the communications manager 820 in accordance with examples as described herein, the device 805 may support techniques for timeline and cancellation considerations for distributed network-encoding which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of timeline and cancellation considerations for distributed network-encoding as described herein, or the processor 840 and the memory 830 may be otherwise configured to perform or support such operations.

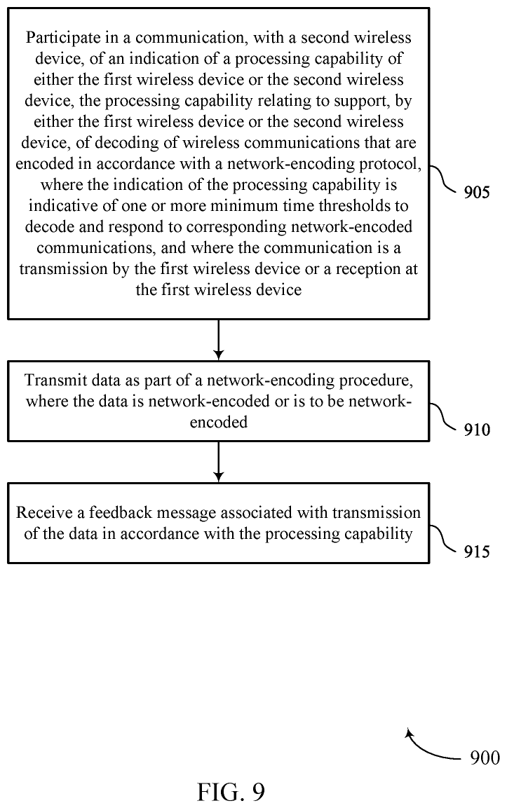

FIG. 9 illustrates a flowchart showing a method 900 that supports timeline and cancellation considerations for distributed network-encoding in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device. The operations of 905 may be performed in accordance with examples as disclosed herein. In some examples, aspects of the operations of 905 may be performed by a capability component 725 as described with reference to FIG. 7.

At 910, the method may include transmitting data as part of a network-encoding procedure, where the data is network-encoded or is to be network-encoded. The operations of 910 may be performed in accordance with examples as disclosed herein. In some examples, aspects of the operations of 910 may be performed by a network-encoding component 730 as described with reference to FIG. 7.

At 915, the method may include receiving a feedback message associated with transmission of the data in accordance with the processing capability. The operations of 915 may be performed in accordance with examples as disclosed herein. In some examples, aspects of the operations of 915 may be performed by a feedback component 735 as described with reference to FIG. 7.

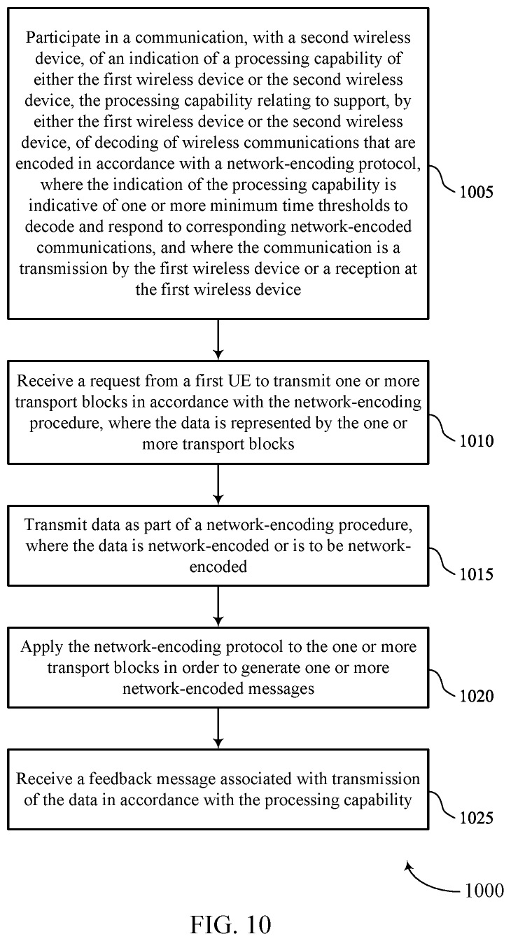

FIG. 10 illustrates a flowchart showing a method 1000 that supports timeline and cancellation considerations for distributed network-encoding in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, where the indication of the processing capability is indicative of one or more minimum time thresholds to decode and respond to corresponding network-encoded communications, and where the communication is a transmission by the first wireless device or a reception at the first wireless device. The operations of 1005 may be performed in accordance with examples as disclosed herein. In some examples, aspects of the operations of 1005 may be performed by a capability component 725 as described with reference to FIG. 7.

At 1010, the method may include receiving a request from a first UE to transmit one or more TBs in accordance with the network-encoding procedure, where the data is represented by the one or more TBs. The operations of 1010 may be performed in accordance with examples as disclosed herein. In some examples, aspects of the operations of 1010 may be performed by a request component 740 as described with reference to FIG. 7.

At 1015, the method may include transmitting data as part of a network-encoding procedure, where the data is network-encoded or is to be network-encoded. The operations of 1015 may be performed in accordance with examples as disclosed herein. In some examples, aspects of the operations of 1015 may be performed by a network-encoding component 730 as described with reference to FIG. 7.

At 1020, the method may include applying the network-encoding protocol to the one or more TBs in order to generate one or more network-encoded messages. The operations of 1020 may be performed in accordance with examples as disclosed herein. In some examples, aspects of the operations of 1020 may be performed by a network-encoding component 730 as described with reference to FIG. 7.

At 1025, the method may include receiving a feedback message associated with transmission of the data in accordance with the processing capability. The operations of 1025 may be performed in accordance with examples as disclosed herein. In some examples, aspects of the operations of 1025 may be performed by a feedback component 735 as described with reference to FIG. 7.

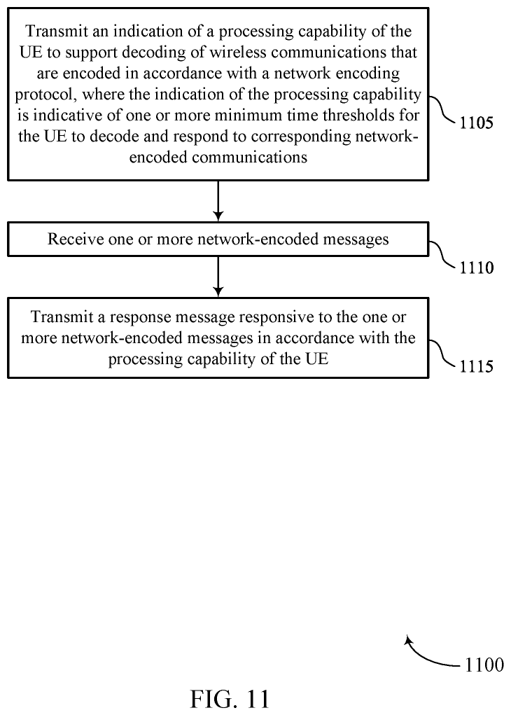

FIG. 11 illustrates a flowchart showing a method 1100 that supports timeline and cancellation considerations for distributed network-encoding in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include transmitting an indication of a processing capability of the UE to support decoding of wireless communications that are encoded in accordance with a network-encoding protocol, where the indication of the processing capability is indicative of one or more minimum time thresholds for the UE to decode and respond to corresponding network-encoded communications. The operations of 1105 may be performed in accordance with examples as disclosed herein. In some examples, aspects of the operations of 1105 may be performed by a capability component 725 as described with reference to FIG. 7.

At 1110, the method may include receiving one or more network-encoded messages. The operations of 1110 may be performed in accordance with examples as disclosed herein. In some examples, aspects of the operations of 1110 may be performed by a network-encoding component 730 as described with reference to FIG. 7.

At 1115, the method may include transmitting a response message responsive to the one or more network-encoded messages in accordance with the processing capability of the UE. The operations of 1115 may be performed in accordance with examples as disclosed herein. In some examples, aspects of the operations of 1115 may be performed by a feedback component 735 as described with reference to FIG. 7.

The following provides an overview of aspects of the present disclosure:

Aspect 1: A method for wireless communications at a first wireless device, comprising: participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, wherein the indication of the processing capability is indicative of one or more minimum time thresholds to decode and respond to corresponding network-encoded communications, and wherein the communication is a transmission by the first wireless device or a reception at the first wireless device; transmitting data as part of a network-encoding procedure, wherein the data is network-encoded or is to be network-encoded; and receiving a feedback message associated with transmission of the data in accordance with the processing capability.

Aspect 2: The method of aspect 1, wherein the one or more minimum time thresholds are at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

Aspect 3: The method of any of aspects 1 through 2, wherein the first wireless device is a network-encoding device, the method further comprising: receiving a request from a first UE to transmit one or more TBs in accordance with the network-encoding procedure, wherein the data is represented by the one or more TBs; and applying the network-encoding protocol to the one or more TBs in order to generate one or more network-encoded messages.

Aspect 4: The method of aspect 3, wherein transmitting the data as part of the network-encoding procedure comprises: transmitting the one or more network-encoded messages to one or more second UEs, responsive to the request from the first UE.

Aspect 5: The method of any of aspects 3 through 4, further comprising: transmitting a second indication of a maximum number of network-encoded messages the first wireless device is to encode and transmit in accordance with the network-encoding procedure,

Aspect 6: The method of aspect 5, wherein the second indication is based on at least one of a buffer capability of the first wireless device, a power capability of the first wireless device, or a utilization capability of the first wireless device.

Aspect 7: The method of any of aspects 3 through 6, wherein receiving the feedback message comprises: monitoring for feedback provided by one or more second UEs to the first UE, wherein the feedback includes the feedback message; and intercepting the feedback message from the one or more second UEs.

Aspect 8: The method of aspect 7, further comprising: determining that the feedback message includes a negative acknowledgment that indicates that at least a portion of the one or more second UEs failed to decode at least a portion of the one or more TBs; encoding the portion of the one or more TBs that were not decoded by the one or more second UEs, in accordance with the network-encoding protocol, in order to generate one or more additional network-encoded messages, wherein TBs for which no negative acknowledgment is received are not represented by the one or more additional network-encoded messages; and transmitting the one or more additional network-encoded messages.

Aspect 9: The method of aspect 7, further comprising: determining that the feedback message includes an acknowledgment that indicates that all of the one or more second UEs decoded all of the one or more TBs; and releasing one or more resources associated with retransmitting the one or more network-encoded messages based at least in part on the determination.

Aspect 10: The method of any of aspects 3 through 9, further comprising: receiving, from the first UE, a reservation message reserving the first wireless device to encode wireless communications in accordance with the network encoding protocol, wherein the one or more network-encoded messages are transmitted based on receipt of the reservation message.

Aspect 11: The method of aspect 10, wherein the reservation message reserves the first wireless device for a specified duration of time.

Aspect 12: The method of aspect 10, further comprising: activating a reservation of the first wireless device by the reservation message upon receipt of an activation message from the first UE; and deactivating the reservation upon receipt of a subsequent deactivation message.

Aspect 13: The method of any of aspects 10 through 12, wherein the reservation message is received over a set of time or frequency resources designated for communication of the reservation message.

Aspect 14: The method of any of aspects 10 through 13, further comprising: receiving, from a second UE, a second reservation message reserving the first wireless device to encode additional wireless communications in accordance with the network encoding protocol, such that the first wireless device is reserved concurrently by both the first UE and the second UE.

Aspect 15: The method of any of aspects 3 through 14, further comprising: receiving a cancellation message that indicates that the first wireless device is to refrain from encoding subsequently-received TBs in accordance with the network encoding protocol.

Aspect 16: The method of any of aspects 3 through 14, further comprising: receiving a transition message that indicates that the first wireless device is to transition from transmitting network-encoded messages to using non-network-encoded repetitions, wherein the transition message is received via a radio resource control message, a medium access control-control element transmission, or a sidelink control information message.

Aspect 17: The method of any of aspects 1 through 2, wherein the first wireless device is a first UE, the method further comprising: transmitting a request from the first UE to a network-encoding device to have the network-encoding device transmit one or more TBs as the one or more network-encoded messages in accordance with the network-encoding procedure, wherein the data is represented by the one or more TBs; and transmitting the one or more TBs to the network-encoding device.

Aspect 18: The method of aspect 17, further comprising: receiving a second indication of a maximum number of network-encoded messages the network-encoding device is to encode and transmit in accordance with the network-encoding procedure,

Aspect 19: The method of aspect 18, wherein the second indication is based on at least one of a buffer capability of the network-encoding device, a power capability of the network-encoding device, or a utilization capability of the network-encoding device.

Aspect 20: The method of any of aspects 17 through 19, further comprising: transmitting, to the network-encoding device, a reservation message reserving the network-encoding device to encode wireless communications in accordance with the network encoding protocol.

Aspect 21: The method of aspect 20, wherein the reservation message reserves the network-encoding device for a specified duration of time.

Aspect 22: The method of any of aspects 20 through 21, wherein the reservation message is transmitted over a set of time or frequency resources designated for communication of the reservation message.

Aspect 23: The method of any of aspects 17 through 22, further comprising: transmitting a cancellation message that indicates that the network-encoding device is to refrain from encoding subsequently-transmitted TBs in accordance with the network encoding protocol.

Aspect 24: The method of any of aspects 17 through 22, further comprising: transmitting a transition message that indicates that the network-encoding device is to transition from transmitting network-encoded messages to using non-network-encoded repetitions, wherein the transition message is transmitted via a radio resource control message, a medium access control-control element transmission, or a sidelink control information message.

Aspect 25: The method of aspect 24, wherein transmitting the cancellation message is based at least in part on a priority of the one or more TBs, a quality of service requirement associated with the one or more TBs, a packet delay budget associated with the one or more TBs, or any combination thereof.

Aspect 26: A method for wireless communications at a UE, comprising: transmitting an indication of a processing capability of the UE to support decoding of wireless communications that are encoded in accordance with a network encoding protocol, wherein the indication of the processing capability is indicative of one or more minimum time thresholds for the UE to decode and respond to corresponding network-encoded communications; receiving one or more network-encoded messages; and transmitting a response message responsive to the one or more network-encoded messages in accordance with the processing capability of the UE.

Aspect 27: The method of aspect 26, wherein the one or more minimum time thresholds are at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

Aspect 28: An apparatus for wireless communications at a first wireless device, comprising a processor; memory coupled with the processor; and instructions stored in the memory and executable by the processor to cause the apparatus to perform a method of any of aspects 1 through 25.

Aspect 29: An apparatus for wireless communications at a first wireless device, comprising at least one means for performing a method of any of aspects 1 through 25.

Aspect 30: A non-transitory computer-readable medium storing code for wireless communications at a first wireless device, the code comprising instructions executable by a processor to perform a method of any of aspects 1 through 25.

Aspect 31: An apparatus for wireless communications at a UE, comprising a processor; memory coupled with the processor; and instructions stored in the memory and executable by the processor to cause the apparatus to perform a method of any of aspects 26 through 27.

Aspect 32: An apparatus for wireless communications at a UE, comprising at least one means for performing a method of any of aspects 26 through 27.

Aspect 33: A non-transitory computer-readable medium storing code for wireless communications at a UE, the code comprising instructions executable by a processor to perform a method of any of aspects 26 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first wireless device, comprising:
a processor;
memory coupled with the processor; and
instructions stored in the memory and executable by the processor to cause the apparatus to:
participate in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, wherein the indication of the processing capability is indicative of one or more minimum time thresholds to decode and respond to corresponding network-encoded communications, and wherein the communication is a transmission by the first wireless device or a reception at the first wireless device;
transmit data as part of a network-encoding procedure, wherein the data is network-encoded or is to be network-encoded; and
receive a feedback message associated with transmission of the data in accordance with the processing capability.

2. The apparatus of claim 1, wherein the one or more minimum time thresholds are at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

3. The apparatus of claim 1, wherein the first wireless device is a network-encoding device, and the instructions are further executable by the processor to cause the apparatus to:
receive a request from a first user equipment (UE) to transmit one or more transport blocks in accordance with the network-encoding procedure, wherein the data is represented by the one or more transport blocks; and
apply the network-encoding protocol to the one or more transport blocks in order to generate one or more network-encoded messages.

4. The apparatus of claim 3, wherein the instructions to transmit the data as part of the network-encoding procedure are executable by the processor to cause the apparatus to:
transmit the one or more network-encoded messages to one or more second UEs, responsive to the request from the first UE.

5. The apparatus of claim 3, wherein the instructions are further executable by the processor to cause the apparatus to:
transmit a second indication of a maximum number of network-encoded messages the first wireless device is to encode and transmit in accordance with the network-encoding procedure.

6. The apparatus of claim 5, wherein the second indication is based on at least one of a buffer capability of the first wireless device, a power capability of the first wireless device, or a utilization capability of the first wireless device.

7. The apparatus of claim 3, wherein the instructions to receive the feedback message are executable by the processor to cause the apparatus to:
monitor for feedback provided by one or more second UEs to the first UE, wherein the feedback includes the feedback message; and
intercept the feedback message from the one or more second UEs.

8. The apparatus of claim 7, wherein the instructions are further executable by the processor to cause the apparatus to:
determine that the feedback message includes a negative acknowledgment that indicates that at least a portion of the one or more second UEs failed to decode at least a portion of the one or more transport blocks;
encode the portion of the one or more transport blocks that were not decoded by the one or more second UEs, in accordance with the network-encoding protocol, in order to generate one or more additional network-encoded messages, wherein transport blocks for which no negative acknowledgment is received are not represented by the one or more additional network-encoded messages; and
transmit the one or more additional network-encoded messages.

9. The apparatus of claim 7, wherein the instructions are further executable by the processor to cause the apparatus to:
determine that the feedback message includes an acknowledgment that indicates that all of the one or more second UEs decoded all of the one or more transport blocks; and
release one or more resources associated with retransmitting the one or more network-encoded messages based at least in part on the determination.

10. The apparatus of claim 3, wherein the instructions are further executable by the processor to cause the apparatus to:
receive, from the first UE, a reservation message reserving the first wireless device to encode wireless communications in accordance with the network-encoding protocol, wherein the one or more network-encoded messages are transmitted based on receipt of the reservation message.

11. The apparatus of claim 10, wherein the reservation message reserves the first wireless device for a specified duration of time.

12. The apparatus of claim 10, wherein the instructions are further executable by the processor to cause the apparatus to:
activate a reservation of the first wireless device by the reservation message upon receipt of an activation message from the first UE; and
deactivate the reservation upon receipt of a subsequent deactivation message.

13. The apparatus of claim 10, wherein the reservation message is received over a set of time or frequency resources designated for communication of the reservation message.

14. The apparatus of claim 10, wherein the instructions are further executable by the processor to cause the apparatus to:
receive, from a second UE, a second reservation message reserving the first wireless device to encode additional wireless communications in accordance with the network-encoding protocol, such that the first wireless device is reserved concurrently by both the first UE and the second UE.

15. The apparatus of claim 3, wherein the instructions are further executable by the processor to cause the apparatus to:
receive a cancellation message that indicates that the first wireless device is to refrain from encoding subsequently-received transport blocks in accordance with the network-encoding protocol.

16. The apparatus of claim 3, wherein the instructions are further executable by the processor to cause the apparatus to:
receive a transition message that indicates that the first wireless device is to transition from transmitting network-encoded messages to using non-network-encoded repetitions, wherein the transition message is received via a radio resource control message, a medium access control-control element transmission, or a sidelink control information message.

17. The apparatus of claim 1, wherein the first wireless device is a first user equipment (UE), and the instructions are further executable by the processor to cause the apparatus to:
transmit a request from the first UE to a network-encoding device to have the network-encoding device transmit one or more transport blocks as one or more network-encoded messages in accordance with the network-encoding procedure, wherein the data is represented by the one or more transport blocks; and
transmit the one or more transport blocks to the network-encoding device.

18. The apparatus of claim 17, wherein the instructions are further executable by the processor to cause the apparatus to:
receive a second indication of a maximum number of network-encoded messages the network-encoding device is to encode and transmit in accordance with the network-encoding procedure.

19. The apparatus of claim 18, wherein the second indication is based on at least one of a buffer capability of the network-encoding device, a power capability of the network-encoding device, or a utilization capability of the network-encoding device.

20. The apparatus of claim 17, wherein the instructions are further executable by the processor to cause the apparatus to:
transmit, to the network-encoding device, a reservation message reserving the network-encoding device to encode wireless communications in accordance with the network-encoding protocol.

21. The apparatus of claim 20, wherein the reservation message reserves the network-encoding device for a specified duration of time.

22. The apparatus of claim 20, wherein the reservation message is transmitted over a set of time or frequency resources designated for communication of the reservation message.

23. The apparatus of claim 17, wherein the instructions are further executable by the processor to cause the apparatus to:
transmit a cancellation message that indicates that the network-encoding device is to refrain from encoding subsequently-transmitted transport blocks in accordance with the network-encoding protocol.

24. The apparatus of claim 17, wherein the instructions are further executable by the processor to cause the apparatus to:
transmit a transition message that indicates that the network-encoding device is to transition from transmitting network-encoded messages to using non-network-encoded repetitions, wherein the transition message is transmitted via a radio resource control message, a medium access control-control element transmission, or a sidelink control information message.

25. The apparatus of claim 24, wherein transmitting the transition message is based at least in part on a priority of the one or more transport blocks, a quality of service requirement associated with the one or more transport blocks, a packet delay budget associated with the one or more transport blocks, or any combination thereof.

26. An apparatus for wireless communications at a user equipment (UE), comprising:
a processor;
memory coupled with the processor; and
instructions stored in the memory and executable by the processor to cause the apparatus to:
transmit an indication of a processing capability of the UE to support decoding of wireless communications that are encoded in accordance with a network-encoding protocol, wherein the indication of the processing capability is indicative of one or more minimum time thresholds for the UE to decode and respond to corresponding network-encoded communications;
receive one or more network-encoded messages; and
transmit a response message responsive to the one or more network-encoded messages in accordance with the processing capability of the UE.

27. The apparatus of claim 26, wherein the one or more minimum time thresholds are at least one of a first minimum time threshold between receipt of a network-encoded downlink data message and transmission of a feedback message associated with the network-encoded downlink data message, a second time threshold between receipt of a network-encoded uplink control message and transmission of an uplink message responsive to the network-encoded uplink control message, or a third time threshold between receipt of a network-encoded sidelink message and transmission of a feedback message associated with the network-encoded sidelink message.

28. A method for wireless communications at a first wireless device, comprising:
participating in a communication, with a second wireless device, of an indication of a processing capability of either the first wireless device or the second wireless device, the processing capability relating to support, by either the first wireless device or the second wireless device, of decoding of wireless communications that are encoded in accordance with a network-encoding protocol, wherein the indication of the processing capability is indicative of one or more minimum time thresholds to decode and respond to corresponding network-encoded communications, and wherein the communication is a transmission by the first wireless device or a reception at the first wireless device;
transmitting data as part of a network-encoding procedure, wherein the data is network-encoded or is to be network-encoded; and
receiving a feedback message associated with transmission of the data in accordance with the processing capability.

29. The method of claim 28, wherein the first wireless device is a network-encoding device, the method further comprising:
receiving a request from a first user equipment (UE) to transmit one or more transport blocks in accordance with the network-encoding procedure, wherein the data is represented by the one or more transport blocks; and
applying the network-encoding protocol to the one or more transport blocks in order to generate one or more network-encoded messages.

30. A method for wireless communications at a user equipment (UE), comprising:
transmitting an indication of a processing capability of the UE to support decoding of wireless communications that are encoded in accordance with a network-encoding protocol, wherein the indication of the processing capability is indicative of one or more minimum time thresholds for the UE to decode and respond to corresponding network-encoded communications;
receiving one or more network-encoded messages; and
transmitting a response message responsive to the one or more network-encoded messages in accordance with the processing capability of the UE.
